(19) United States
(12) Patent Application Publication
(10) Pub. No.: US 2005/0134609 A1
(43) Pub. Date: Jun. 23, 2005

(54) Mapping assessment program

(76) Inventor: George W. Yu, Annapolis, MD (US)

Correspondence Address: FROMMER LAWRENCE & HAUG, 745 FIFTH AVENUE- 10TH FL., NEW YORK, NY, 10151, US

(21) Appl. No.: 10/865,024

(22) Filed: Jun. 10, 2004

Related U.S. Application Data
(60) Provisional application No. 60/477,461, filed on Jun. 10, 2003.

(51) Int. Cl. G09G 5/00

(52) U.S. Cl. 345/629

(57) ABSTRACT

A system and method for graphically organizing information. A representation of an item to which the information relates is provided, and one or more points are superimposed on the representation to indicate areas of the item that correspond to the information. The points correspond to coordinates within a reference frame that is used to delineate positions on the representation.

### CROSS-REFERENCE TO RELATED APPLICATION

This application claims priority to provisional application Ser. No. 60/477,461 filed Jun. 10, 2003 entitled “Mapping Assessment Program” incorporated herein by reference, together with any documents therein cited and any documents cited or referenced in their cited documents.

### FIELD OF THE INVENTION

A method and a program to cataloguing, organizing and packaging information by systematically organizing the information in coordinates and assigning a dot code and/or a bar code to the information. The present invention also provides a business process and technical implementation for a Mapping Assessment Program (“MAP”).

### BACKGROUND OF THE INVENTION

Geographical locations have since been described by human in terms of coordinates. No one has however, thought of describing a human body, an automobile engine, a picture, a corporation in and any other object in terms of co ordinates in order to better catalogue, organize and package information in order to facilitates access of information.

### SUMMARY OF THE INVENTION

The present invention teaches and discloses a method of cataloging, organizing and packaging information for easy access by assigning coordinates to all objects, including but not limited to human body, buildings, corporate organization, automobiles in coordinates. The process of the present invention teaches a method to capture specifics regarding key attributes of a system and display the captured information in at least one-dimensional visual space overlaid on an image of the system.

### BRIEF DESCRIPTION OF THE DRAWINGS

The following Description, given by way of example, is not intended to limit the invention to any specific embodiments described. The Description may be understood in conjunction with the accompanying Figures, incorporated herein by reference.

FIG. 1 shows a Mapping Assessment Program (“MAP”) medical record of a first embodiment in a accordance with the present invention.

FIG. 2 shows a MAP engine of a second embodiment in accordance with the present invention.

FIG. 3 shows a MAP tank of a third embodiment in accordance with the present invention.

FIG. 4 shows how a CD replaces thousands of pages.

FIG. 5 shows the shortcoming of the existing technology in cataloging and organizing information.

FIG. 6 shows the current method of storing and accessing data.

FIG. 7 shows a military medical record.

FIG. 8 shows how a human body can be cataloged and assigned coordinates in accordance with the present invention.

FIG. 9 shows an anatomical dot code in accordance with the present invention.

FIG. 10 shows a flow chart of the present invention.

FIG. 11 shows examples of anatomical icons in accordance with the present invention.

FIG. 12 shows a screen shot of a dot code of a human body which provides information by illness and time.

FIG. 13 shows a screen shot of a dot code of a human body which provides medical history by medication in accordance with the present invention.

FIG. 14 is a screen shot showing an example of cataloging a heart disease in accordance with the present invention.

FIG. 15 is a screen shot showing an example of available categories to input information in accordance with the present invention.

FIG. 16 shows a screen shot in accordance with the present invention.

FIG. 17 shows a screen shot in accordance with the present invention.

FIG. 18 shows an information visualization and digital imaging in accordance with the present invention.

FIG. 19 shows examples of application of MAP in accordance with the present invention.

FIG. 20 shows an example of tracking an effect of a medication in accordance with the present invention.

### DETAILED DESCRIPTION OF THE PRESENT INVENTION

The following Description, given by way of example, is not intended to limit the invention to any specific embodiments described. The Description may be understood in conjunction with the accompanying Figures, incorporated herein by reference.

The Mapping Assessment Program (MAP) of the present invention utilizes a graphical user interface (“GUI”) to organize and integrate data into a pictographic display for users to easily access information. The graphical user interface comprises a grid displayed over the item of interest. Each box on the grid corresponds to a specific information relating to a portion of an item that the grid box overlaid. Selection of different grids on the item displayed also creates a unique dot-code (similar to a bar code) for individuals and helps to collect and organize information. The application of the present invention is limitless. Exemplary items under which the grid is displayed and information organized for include but not limited to a human body, an automobile engine, a picture, corporation, and conflict resolution.

MAP, which stands for Mapping Assessment Program, takes advantage of GUI or Graphic User Interface and goes one step further by putting everything studied (any structure, body, buildings, machinery and even intellectual concepts) into a grid-like map with many points which has a number and letter assigned to it. Once a MAP is made, it assigns information to the individual cubical. This process is termed “Filtering” similar to using a coffee filter after the raw coffee beans are ground. MAP in accordance with the present invention can also sort more varieties of particles just as machines that sort coins from quarters, nickels, dimes and pennies. MAP enables the speedy and easy organization of any information into structured packages. These packages are then assigned a dot code and/or a bar code for identification and cataloging purposes.

MAP 1, which stands for Medical Assessment Passport, uses a human body as the background picture and overlays a map grid over it making a so called HUMAN ANATOMICAL BAR CODE (or a DOT CODE) with supporting icons (HUMAN ORGANS) as a tool to organize and navigate the health database for an individual and/or a large groups of people in a study or in an emergency or in a medical treatment.

MAP 1 is capable of filtering medical information and packaging the information into useable packages by mapping pictures and relating pictures to words (text) and numbers by association. Therefore, MAP 1 organizes and packages all information into medical dot code (like bar code) to enable a health care professional to obtain, retrieve and enter information. The present invention is designed to catalogue, organize, package and utilize information-containing graphics for easy access to information of desire.

For example, a health care individual using MAP 1 can open a bar code or a dot code assigned to a patient of interest and get a quick bird's-eye view of the medical problems of the patient including medical and prescription history. Because the bar code and/or the dot code can be organized electronically, this will enable the health care profession to obtain the medical history of the patient with a few keystrokes on a computer without mobilizing human workforce. In addition, it also helps the health care profession to obtain a complete medical history of the patient without relying on the patient. This is particularly helpful in an emergency situation and/or when the patient has traveled outside of his hometown. This is particularly helpful in view of the fact that 23% of the medical errors are partially attributable to the breakdown of communication. MAP also cuts down the need to enter pages after pages of detailed medical history thus, enables the health care professionals to spend more time with the patients thus, improves healthcare of the patient.

The present invention also does not require a highly skilled worker to enter the data nor does it require extensive training before an individual learn to use the program.

The MAP concept started over a decade ago, but it was not until now that the electronic informational transfer has become so facile that this idea can finally be realized.

MAP 1 in accordance with the present invention can be used on an individual level (Micro Level) or on a group of people (Macro Level) and provides a bird's-eye view. An individual can choose to open a human bar code or a dot code on an individual to review his medical problems in one pictogram and study it. This is particularly helpful in emergency medical care or in a doctor's office. In addition, the Human Bar Code in accordance with the present invention can also be used to tabulate the frequency for the occurrence of certain diseases in certain geographical location. The present invention encompasses both clinical as well as a large study for epidemiological or surveillance purpose in an instant as quickly as swiping a bar code in the grocery store.

Since the Clinton administration in 1996, the HIPAA (Health Insurance Portability and Accountability Act) mandates that health data is as private as financial data, and that an individual has the right to access it. Because MAP 1 is a pictographic tool, it is easily understandable by all walks of life. MAP 1 is also a learning process where a non-doctor begins to associate “body parts” points to malfunction (disease ICD), and to treatments (CPT) and other texts.

MAP can be transmitted through the World Wide Web and/or via telephone line and/or Internet with encryption and security thus, making it accessible to those who are entitled to access it. Government agencies, hospitals, institutions and insurances can use it if permission is granted.

The application for MAP is limitless. In addition to its health care application, it is also applicable for any structures, objects, concepts, corporate organization and intellectual properties.

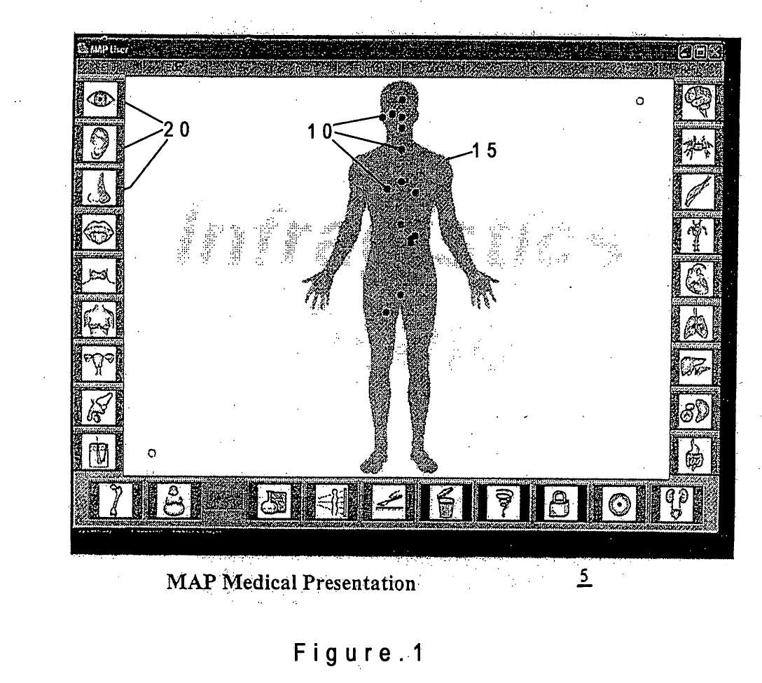

The present invention teaches a business process, method and technical implementation of a Mapping Assessment Program (MAP) capable of indexing, categorizing and sorting any information including but not limited to medical information, architectural structure, corporate structure and any and all objects and/or subjects that can be mapped in two-dimensional and/or three dimensional coordinates. The business process of MAP is to capture specifics regarding key attributes of a system and to display that captured information in a multi-dimensional visual space overlaid on an image of the system. Systems can include both physical entities as well as intellectual concepts. The visual overlay of information produces a unique dot-code (similar to a bar code) the uniquely identifies the state of the system. Common states between systems can be determined by analyzing the dot-codes of the systems. More particularly, MAP in accordance with the present invention teaches a business process directs specific attributes of a system in a multi-dimensional (X Y Z planes over time) visual based presentation. For a medical implementation, the MAP system addresses multiple classes of human characteristics (symptoms, diseases, operations, medications, etc.) and relates these items using a time-based chronology. Typical MAP views across multiple domains are shown in FIGS. 1, 2 and 3.

The primary interface of a user with the MAP system is with families of icons. This approach provides an intuitive interface that is quickly understood by the general population without unique specialty training. The interface is designed to be operated consistently across multiple user platforms including traditional workstations (Windows PCs, Unix Graphics Workstations, Macintosh Computers, etc.), touch-screen and tablet computes, and Personal Digital Assistants (PDA). This is accomplished by using multiple layout style sheets that are adapted for the various platforms without user interventions.

The implementation of the MAP system uniquely encodes the user information for use in the display and evaluation of the data. User data is captured in multiple dimensions including class of information (For the human system, these can be symptom, disease, operation, medication), reference location, and date of occurrence. This data allows for multiple presentation views and the evaluation of data classes (by symptom, by date, by date window, etc.) using the same base information. Analysis of the user data by multiple views, within the same application, allows for the identification of new patterns of information (e.g. groups of symptoms in time windows).

The presentation of the data involves the proper registration of the user data with a graphically accurate base image. This is accomplished by the implementation of a reference table that relates the information to specific positions on the base image. User data that includes uniquely entered position information (e.g., manually placed symptoms) and encoded as positions in relation to known reference positions. This allows for the revision and updating of the base reference information while preserving the accuracy of the manually positioned data.

Unique to the design and implementation of the MAP system is the generalization of the informational approach (attributes of a system and the presentation of those attributes on an image of the system) and the configuration of unique MAP implementations (e.g., human body, military, and automobiles) as shown for example, in FIGS. 1, 2 and 3. The same core class of MAP implementation can be tailored for specific domains without re-implementation of the underlying capability.

Also unique to the design and implementation of the MAP system is the ability to import information from external sources (e.g., medical laboratory test results in the medical domain) and relate this data to the base information. This allows the MAP system to extend its analysis capabilities by including a larger body of knowledge.

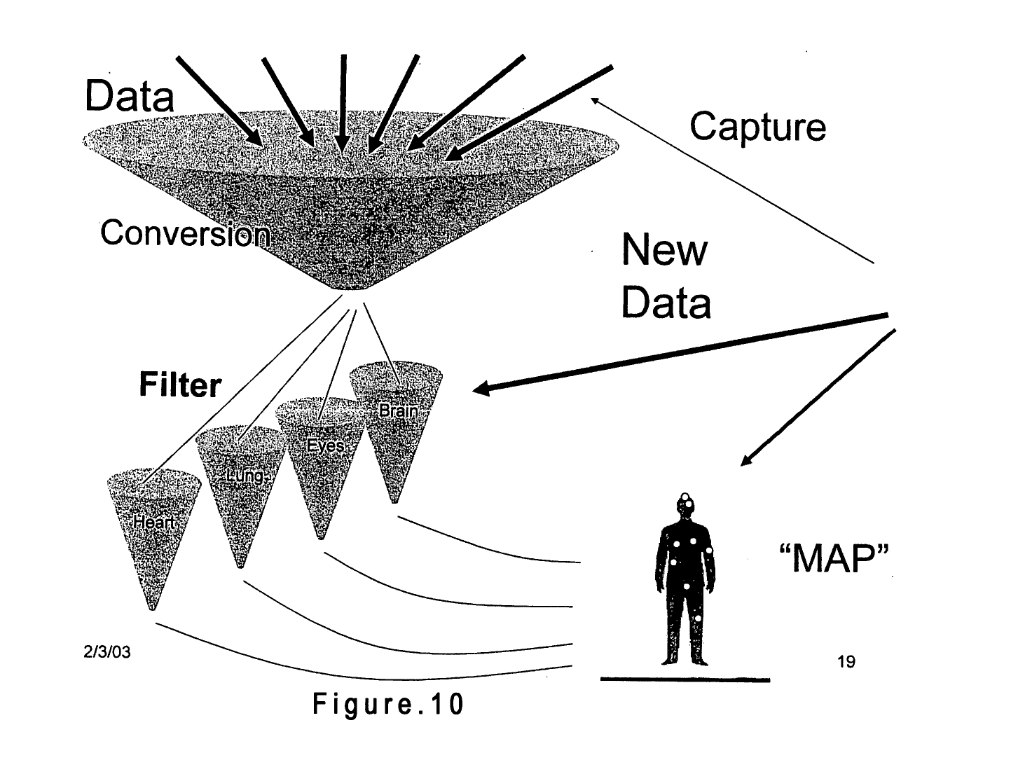

Therefore, the process as described in accordance with FIG. 10, which is a flow chart showing one aspect of the MAP system.

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not limiting.

Attached Appendices I, II and III provide further description of the invention in general and present several illustrative embodiments of the invention. Appendix I is a “nutshell” description of MAP. Appendix II is a brief description of the MAP Technical Concept. Appendix III is a series of presentation frames concerning MAP.

FIGS. 1-20 provide a visually intensive description of invention.

FIG. 1 shows a Mapping Assessment Program (“MAP”) medical record of a first embodiment in a accordance with the present invention. The record is displayed in a GUI screen presentation 5. The GUI screen presentation includes a number of points 10 superimposed on a picture of a human body 15. The points, when considered as a group, make up the dot code associated with a particular person. When considered individually, each point indicates pertinent medical information about the person, the pertinent information being related a part of the human body corresponding to the point's position in the picture. A user of the GUI could use a device such as a mouse to select a displayed point and thereby obtain more information regarding the medical information associated with the selected point. For example, a user may click on the point associated with the person's right ear and thereby obtain a textual description of the medical history for the person's right ear.

FIG. 1 further includes a number of supporting icons 20. The supporting icons include a number icons corresponding to various body parts. A supporting icon for a particular body part may be selected by a user to obtain more detailed information about the body part in general, and/or to obtain more detailed information as to the history the body part for a particular person.

The GUI screen of FIG. 1 does not include the display of a grid. However, a grid could be displayed for purposes of providing a frame of reference for the displayed points. Further, the points could be referenced to a grid even if the grid is not displayed.

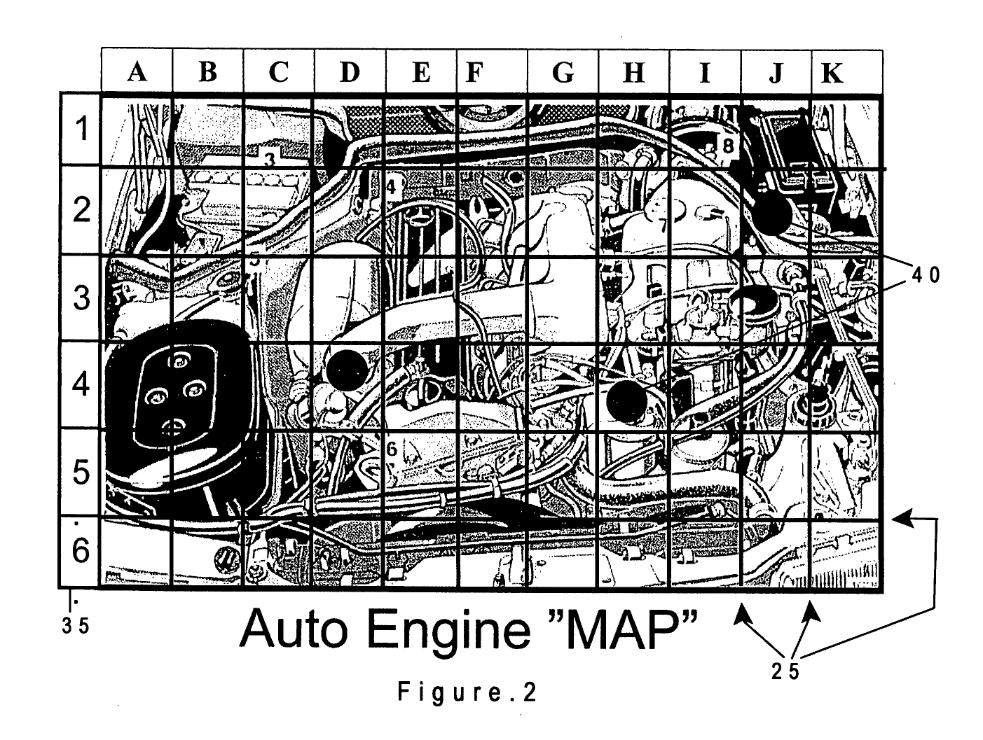

FIG. 2 shows a MAP engine of a second embodiment in accordance with the present invention. The figure includes a grid 25 superimposed on a representation of an automobile engine. The boxes within the grid are delineated by letters 30 and numbers 35, the letters indicating column position and the numbers indicating row position. The boxes designated as D-4, H-4 and J-2 include respective points 40. The points indicate areas of interest within the engine, such as areas that have a repair history. A user of the MAP could select one or more of the points to obtain more detailed information concerning the area of the engine delineated by the grid box(es) in which the selected point(s) are located.

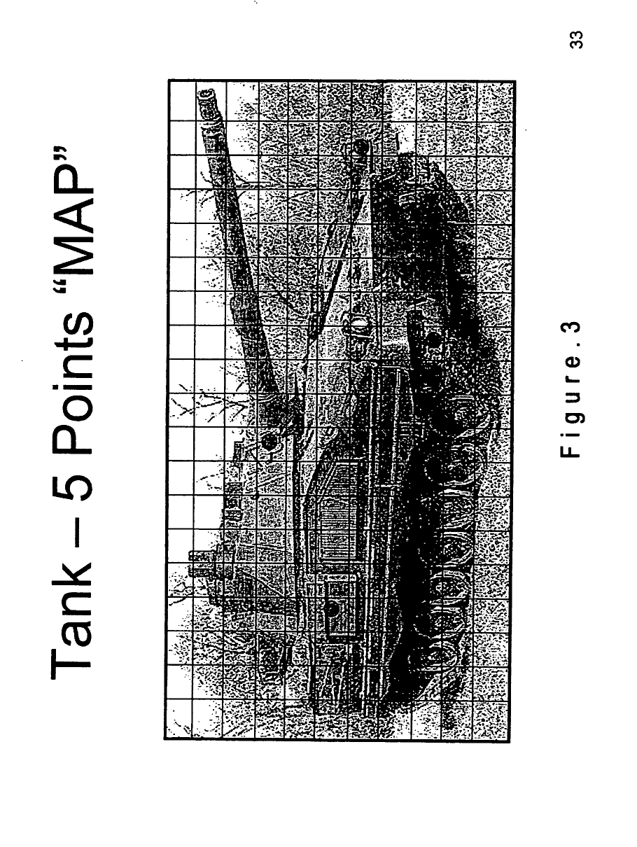

FIG. 3 shows a MAP tank of a third embodiment in accordance with the present invention. A grid 45 is superimposed on the tank, and points of interest within the grid are denoted by points 50.

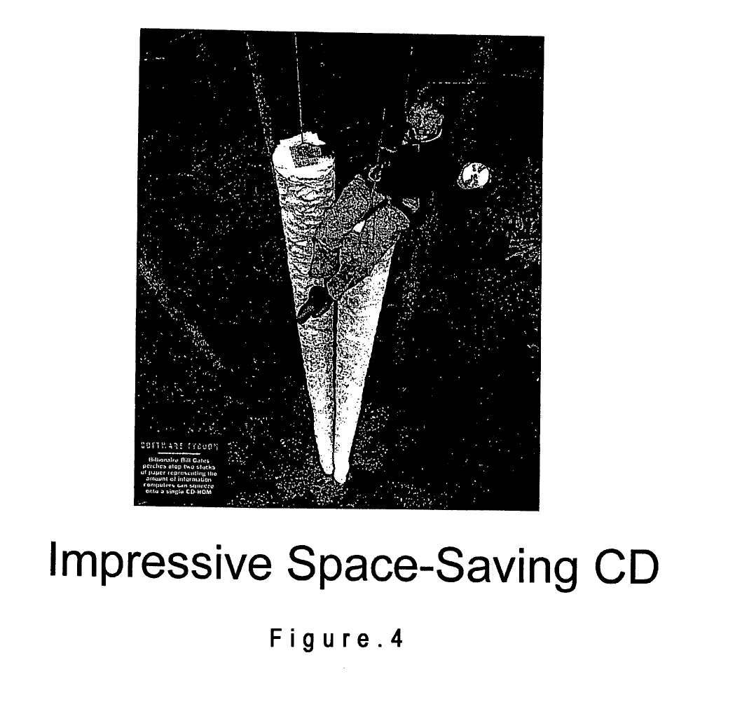

FIG. 4 shows how a CD replaces thousands of pages.

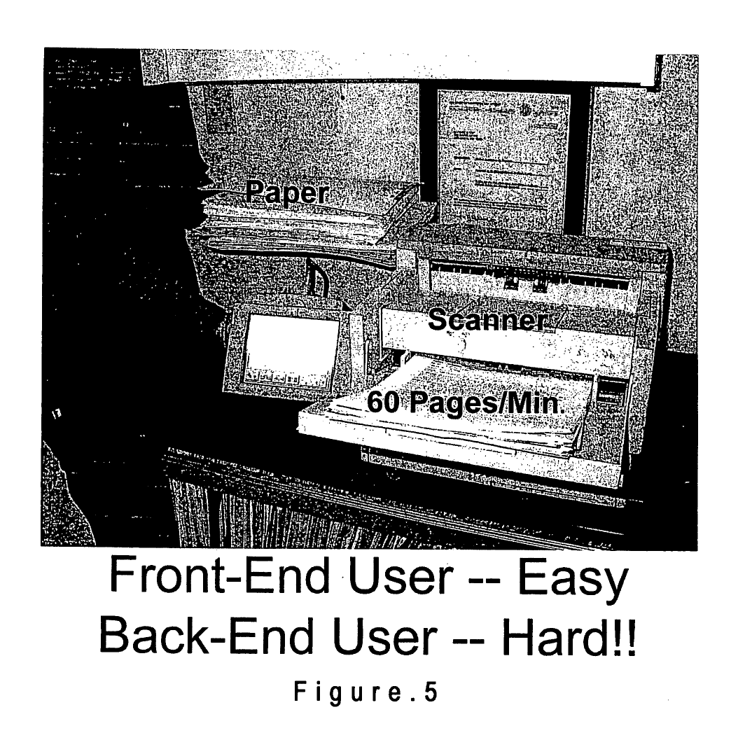

FIG. 5 shows the shortcoming of the existing technology in cataloging and organizing information.

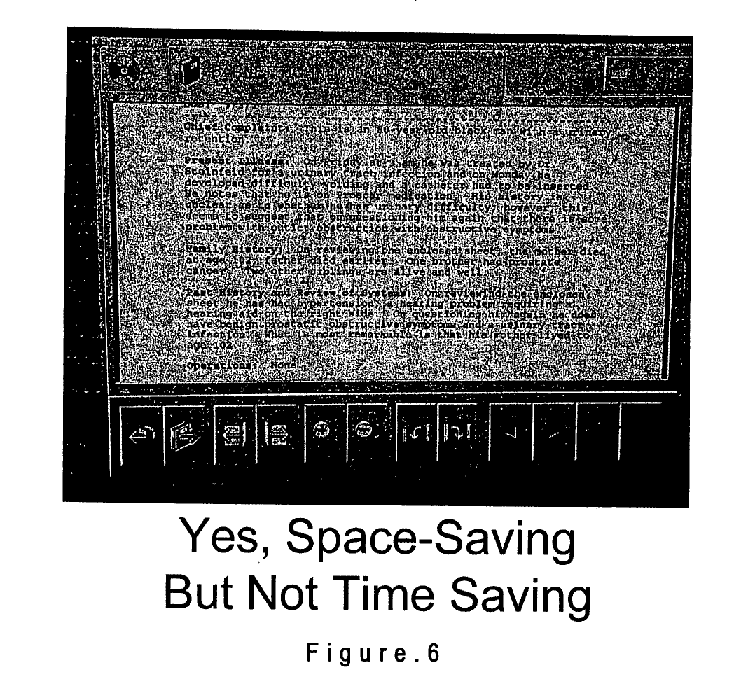

FIG. 6 shows the current method of storing and accessing data.

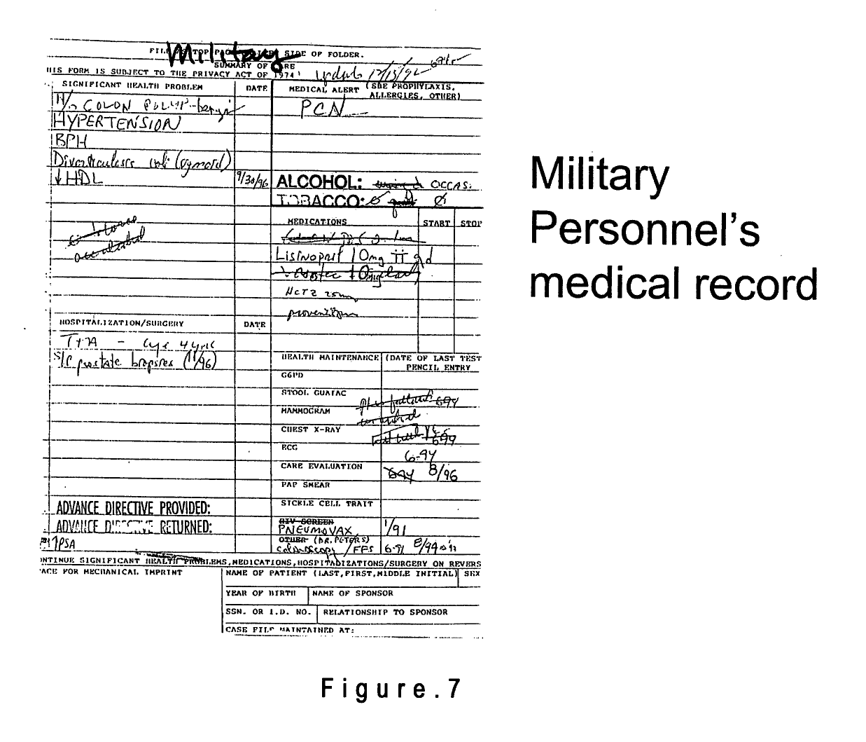

FIG. 7 shows a military medical record.

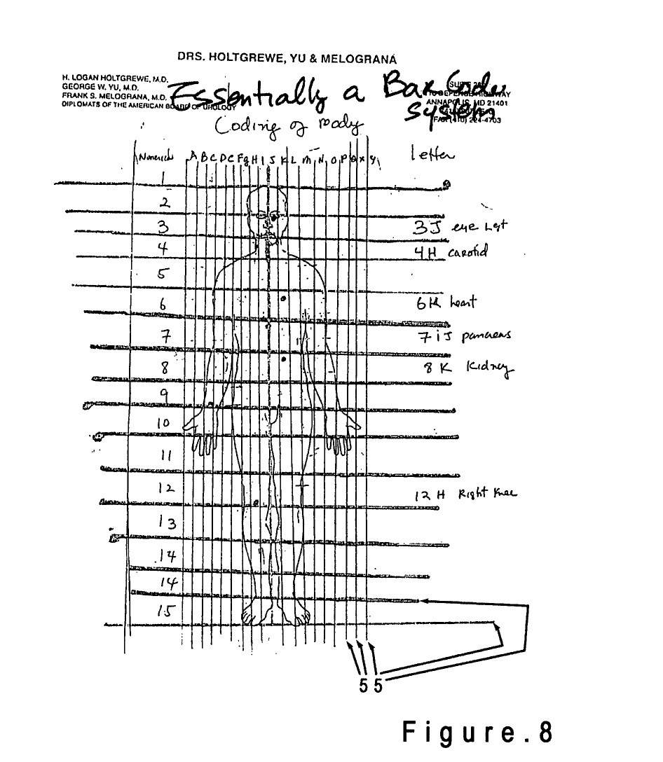

FIG. 8 shows how a human body can be cataloged and assigned coordinates in accordance with the present invention. The human body depiction and points shown in the figure are analogous to the body depiction and points of FIG. 1. However, FIG. 8 includes a superimposed grid 55.

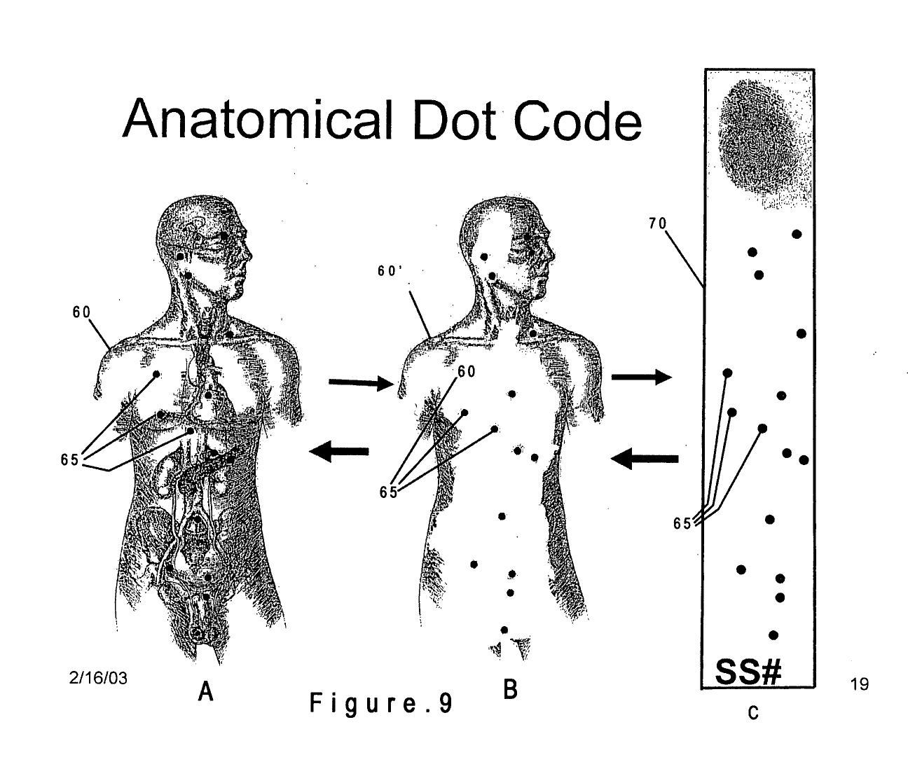

FIG. 9 shows an anatomical dot code in accordance with the present invention. The figure includes three possible representations of the dot code, A, B and C. In representation A, dots 65 making up a dot code are superimposed on a relatively detailed picture of a human body 60. In representation B, the dot code is superimposed on a relatively less detailed picture of a human body 60′. In representation C, the dot code is superimposed on a two dimensional space 70 that includes a finger print identification of the person to whom the dot code corresponds.

FIG. 10 shows a flow chart of the present invention.

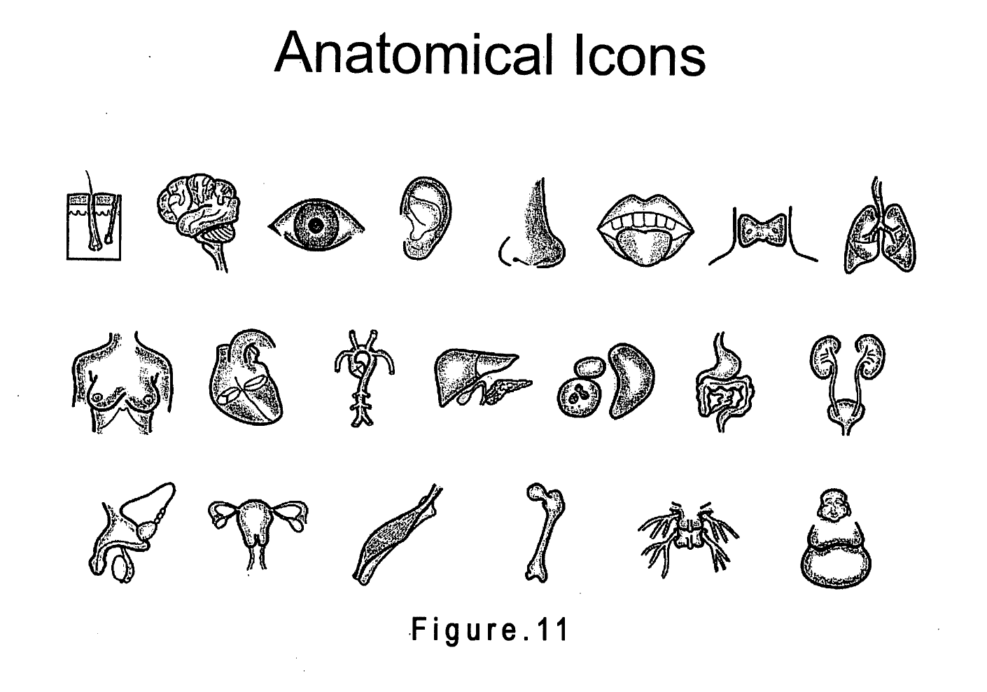

FIG. 11 shows examples of anatomical icons in accordance with the present invention. The icons could be used, for example, as the supporting icons depicted in FIG. 1.

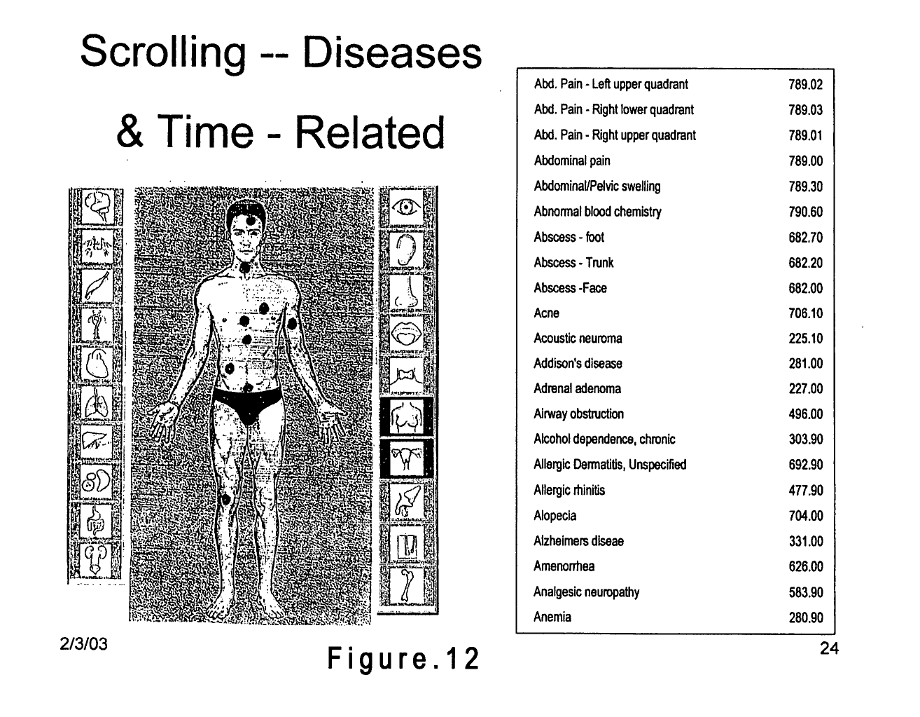

FIG. 12 shows a screen shot of a dot code of a human body which provides information by illness and time.

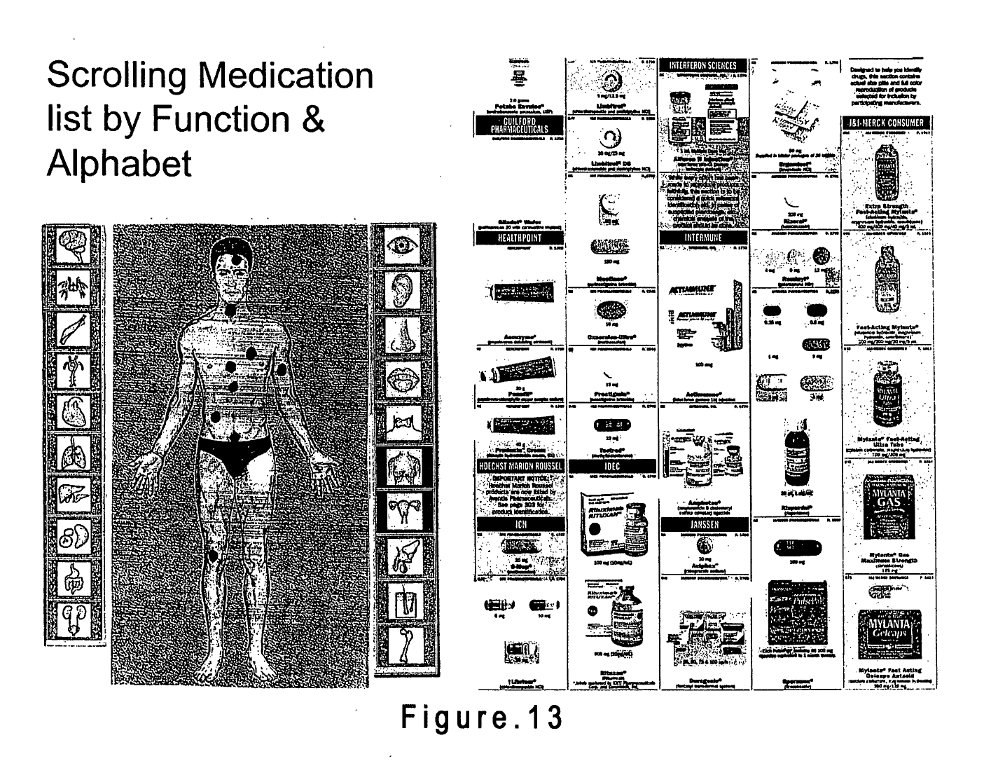

FIG. 13 shows a screen shot of a dot code of a human body which provides medical history by medication in accordance with the present invention.

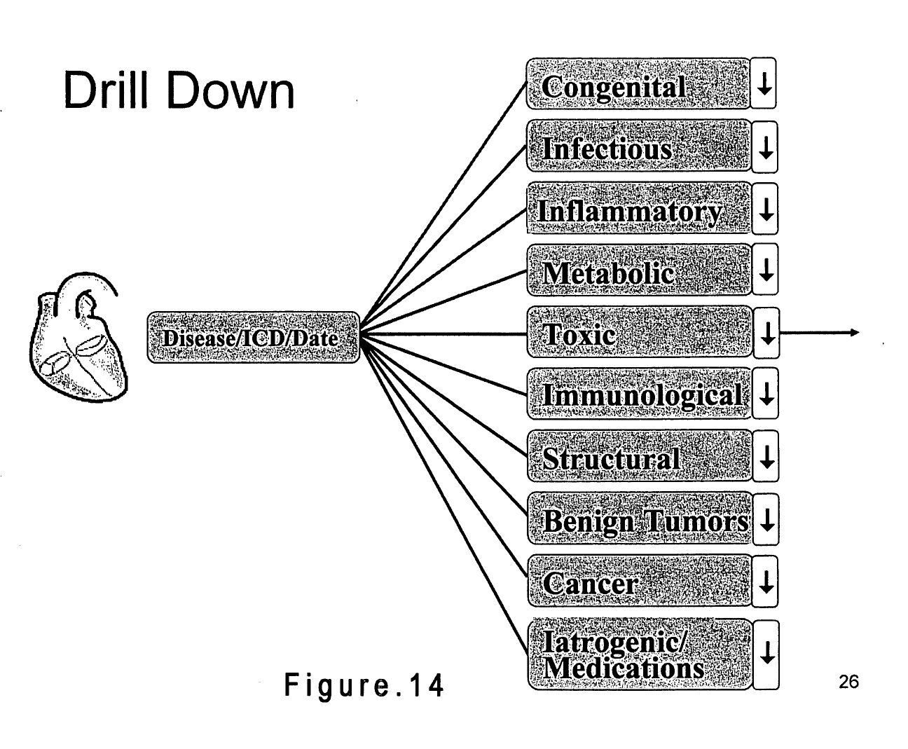

FIG. 14 is a screen shot showing an example of cataloging a heart disease in accordance with the present invention.

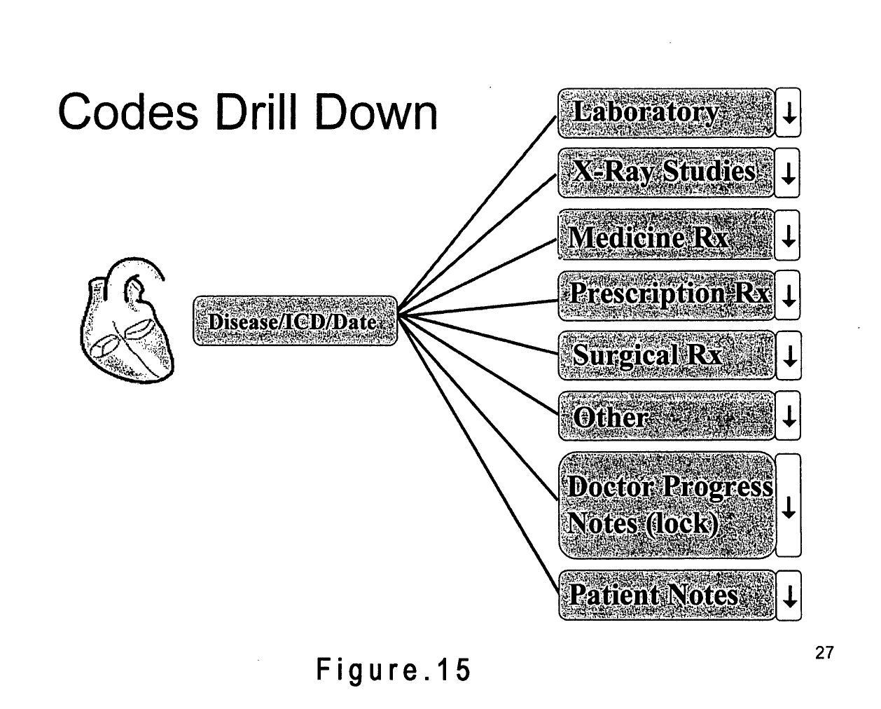

FIG. 15 is a screen shot showing an example of available categories to input information in accordance with the present invention.

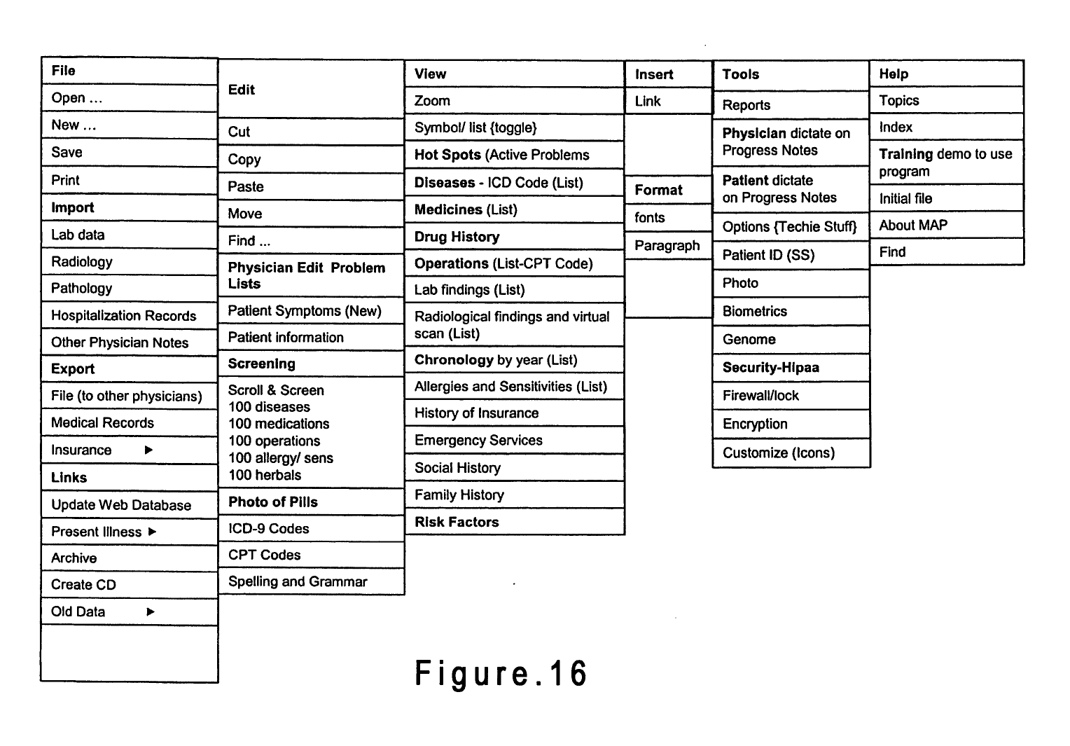

FIG. 16 shows a screen shot in accordance with the present invention.

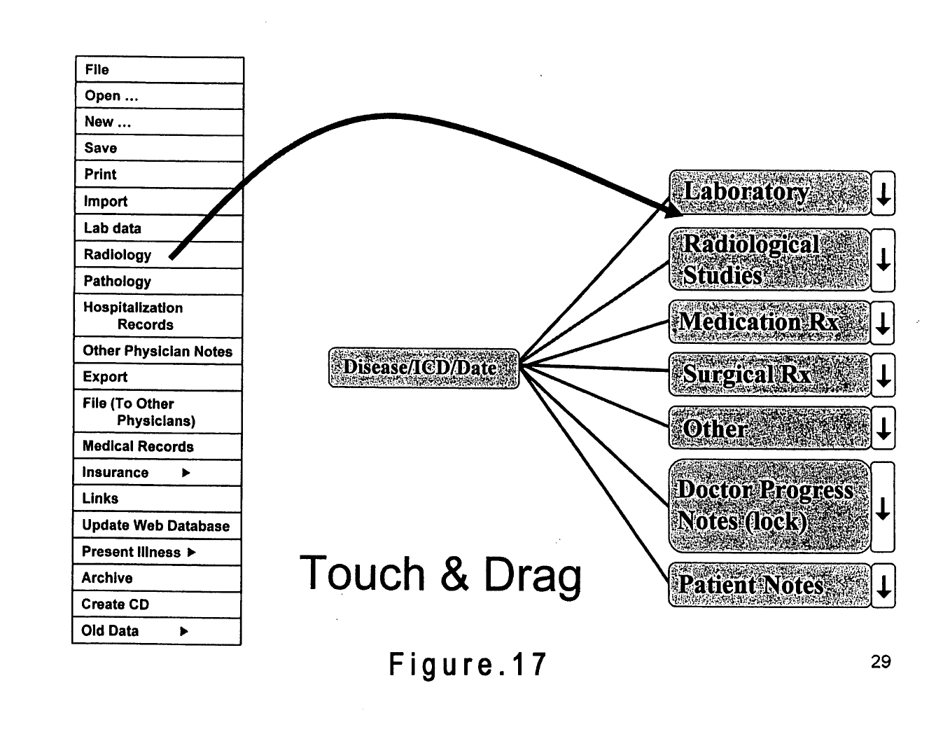

FIG. 17 shows a screen shot in accordance with the present invention.

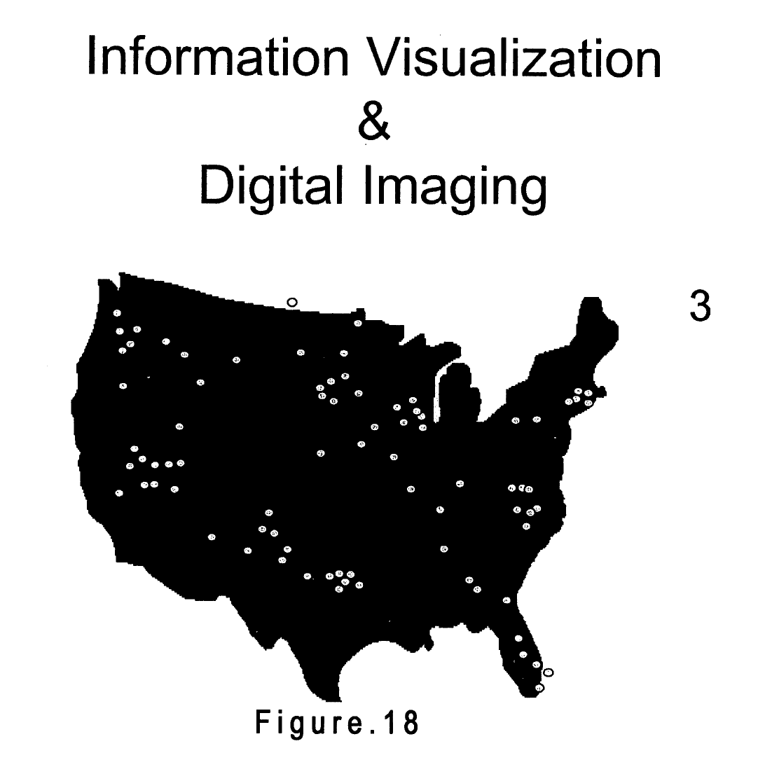

FIG. 18 shows an information visualization and digital imaging in accordance with the present invention.

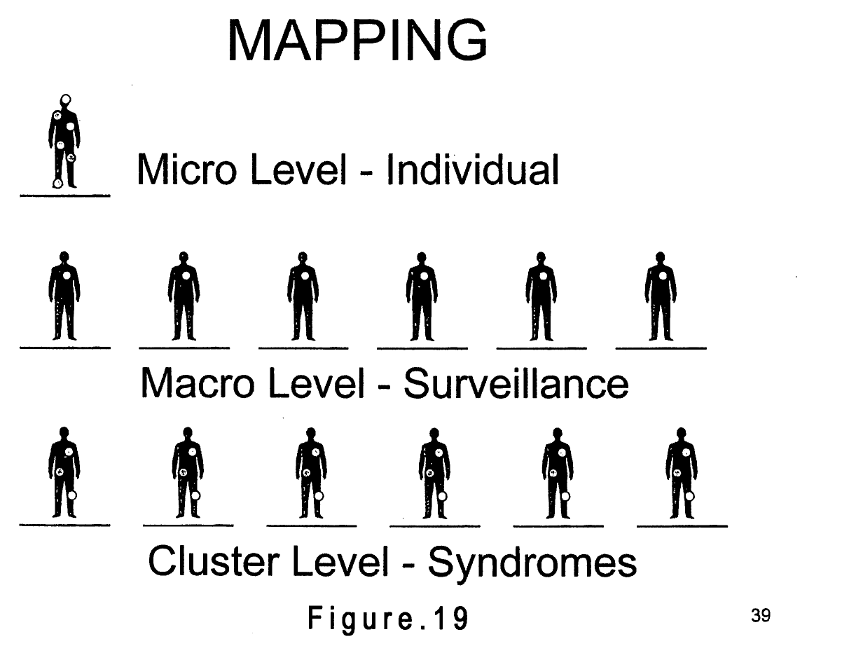

FIG. 19 shows examples of application of MAP in accordance with the present invention.

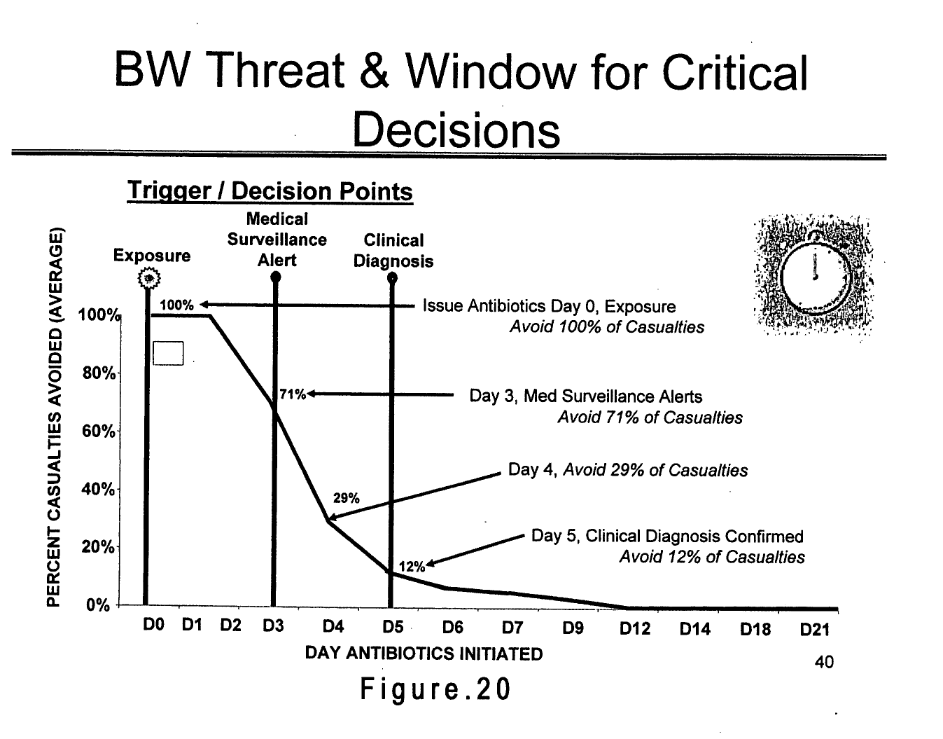

FIG. 20 shows an example of tracking an effect of a medication in accordance with the present invention.

While the invention has been described by way of example and in terms of the preferred embodiment, it is to be understood that the invention is not limited to the disclosed embodiments. To the contrary, it is intended to cover various embodiments of the present invention (as would be apparent to those skilled in the art). Therefore, the scope of the appended claims should be accorded the broadest interpretation so as to encompass all such modifications and similar arrangements.

In this disclosure, “comprises”, “comprising” and the like can have the meaning ascribed to them in U.S. Patent Law and can mean “includes”, “including” and the like.

1. A system for graphically organizing information, comprising:
a representation of an item to which the information is related; and
one or more points superimposed on said representation of said item to indicate areas of said item that correspond to the information;
whereby said points correspond to coordinates within a reference frame that is used to delineate positions on said representation of said item.

2. The system according to claim 1, wherein said item is a human body.

3. The system according to claim 1, further comprising supporting icons that may be selected to obtain further information about said item.

4. The system according to claim 1, wherein the position(s) of said point(s) are used to identify said item from among a plurality of similar items.

5. The system according to claim 4, wherein said item is a person and said points are used to identify said person among a plurality of persons.

6. A method for graphically organizing information, comprising the steps of:
providing a representation of an item to which the information is related; and
superimposing one or more points on said representation of said item to indicate areas of said item that correspond to the information;
whereby said points correspond to coordinates within a reference frame that is used to delineate positions on said representation of said item.

7. The method according to claim 6, wherein said item is a human body.

8. The method according to claim 6, further comprising the step of providing supporting icons that may be selected to obtain further information about said item.

9. The method according to claim 6, wherein the position(s) of said point(s) are used to identify said item from among a plurality of similar items.

10. The method according to claim 9, wherein said item is a person and said points are used to identify said person among a plurality of persons.

11. A recording medium storing a computer program for use in graphically organizing information, the computer program comprising the steps of:
providing a representation of an item to which the information is related; and
superimposing one or more points on said representation of said item to indicate areas of said item that correspond to the information;
whereby said points correspond to coordinates within a reference frame that is used to delineate positions on said representation of said item.

12. The medium according to claim 11, wherein said item is a human body.

13. The medium according to claim 11, wherein the computer program further comprises the step of providing supporting icons that may be selected to obtain further information about said item.

14. The medium according to claim 11, wherein the position(s) of said point(s) are used to identify said item from among a plurality of similar items.

15. The medium according to claim 14, wherein said item is a person and said points are used to identify said person among a plurality of persons.
